(19) United States
(12) Patent Application Publication
(10) Pub. No.: US 2026/0098782 A1
(43) Pub. Date: Apr. 9, 2026

(54) OPTO-ACOUSTIC INTERROGATOR SYSTEM

(71) Applicant: Nederlandse Organisatie voor toegepast-natuurwetenschappelijk onderzoek TNO, 's-Gravenhage (NL)

(72) Inventors: Daniele PIRAS, Amsterdam (NL); Paul Louis Maria Joseph VAN NEER, Bergschenhoek (NL); Benoit André Jacques QUESSON, 's-Gravenhage (NL); Gerini GIAMPIERO, 's-Gravenhage (NL); Tiberiu CECCOTTI, Delft (NL)

(21) Appl. No.: 19/110,364

(22) PCT Filed: Sep. 15, 2023
(86) PCT No.: PCT/NL2023/050482

§ 371 Date: Mar. 10, 2025

(30) Foreign Application Priority Data
Sep. 15, 2022 (EP) 22195976.0
Sep. 15, 2022 (EP) 22195983.6
Sep. 15, 2022 (EP) 22195984.4

(51) Int. Cl. G01M 5/00

(52) U.S. Cl. CPC G01M 5/0066; G01M 5/0091

(57) ABSTRACT

An opto-acoustic interrogator system and method for acoustically interrogating a solid structure. An optical waveguide is configured to receive an optical signal and guide the optical signal to a plurality of opto-acoustic couplers arranged at a plurality of positions along the optical waveguide. Respective opto-acoustic couplers are configured to couple respective parts of the optical signal from the optical waveguide into respective opto-acoustic conversion materials arranged at the plurality of positions, such that respective acoustic signals are generated by different opto-acoustic couplers based on different wavelengths of light in the optical signal.

### CROSS-REFERENCE TO RELATED APPLICATIONS

This application claims priority to European Patent Applications numbers 22195976.0, 22195983.6, and 22195984.4, each filed Sep. 15, 2022. The entire disclosure of the foregoing applications is incorporated by reference herein in its entirety.

### TECHNICAL FIELD AND BACKGROUND

The present disclosure relates to opto-acoustic interrogator systems and methods, e.g., for acoustically interrogating a solid structure.

To meet the Paris Agreement goals offshore wind energy production will increase fifteenfold by 2040. Offshore wind turbines are high value assets, currently equipped with limited number of sensors. Wind turbine blades require: 1) Waveguide optic sensor in the wind turbine blade since electrical sensors get easily damaged by lightning strikes, 2) Large area monitoring of the blade health during fabrication, transport & operation.

For example, a solid structure such as a wind turbine can be inspected for manufacturing flaws and/or wear and damage that arises during use by means of optically excited and/or detected acoustic signals, usually in a form of ultrasound. The ultrasound in the solid structure can be excited by absorption of light in an opto-acoustic conversion material where the light emerges from an optical fiber. Typically, the opto-acoustic conversion material is placed on the fiber end-facet where the area is quite limited. Ultrasound propagation measurement results are sensitive to properties of the solid structure along ultrasound propagation paths. Changes of these properties due to flaws anywhere along a propagation path can result in reduced or delayed transmission, scattering and reflection or to changes in attenuation of the ultrasound waves propagating in through the solid structure. Such changes affect detected signals at a position of detection of the ultrasound waves in the solid structure in response to excitation of the ultrasound at a position of excitation. Reduced or delayed transmission affects the result of transmission along a direct path between such positions. Scattering and reflection can give rise to contributions from new ultrasound propagation paths. By comparing measurement results with baseline measurement results it can be detected whether such changes have occurred due to flaws. The use of ultrasound signals makes it possible to perform frequent, or even continuous inspection during use of the solid structure. However, the frequency of monitoring maybe a trade-off between the number sensors that can be fitted on the solid structure, size of the solid structure and (bandwidth) limitations of the read-out.

As background, US 2013/0129275 A1 describes an encapsulated fiber optic sensor and illustrates an ultrasonic piezoelectric-fiber optic sensor. Piezoelectric-based sensors, however, require electric components which are to be avoided for, e.g., said purpose of monitoring health of a wind turbine blade.

There remains need of a fully optical opto-acoustic interrogator system and method thereof.

### SUMMARY

Aspects of the present disclosure relate to an opto-acoustic interrogator system for acoustically interrogating a solid structure. The system comprises an optical waveguide configured to receive an optical signal and guide the optical signal to a plurality of opto-acoustic couplers arranged at a plurality of positions along the optical waveguide. Advantageously, by using a plurality of opto-acoustic couplers, light from a single optical waveguide can be selectively outcoupled at a plurality of positions without the need of guiding the light via multiple waveguides, thus saving space on the solid structure.

In one aspect of the present disclosure, the plurality of opto-acoustic couplers comprises a first opto-acoustic coupler configured to couple a first part of the optical signal from the optical waveguide into a first opto-acoustic conversion material arranged at a first position of the plurality of positions. In another or further embodiment, the first part of the optical signal comprises light having a first wavelength and the first opto-acoustic conversion material is configured to absorb the light having the first wavelength for generating a first acoustic signal.

In another or further aspect of the present disclosure, the plurality of opto-acoustic couplers comprises a second opto-acoustic coupler configured to couple a second part of the optical signal from the optical waveguide into a second opto-acoustic conversion material arranged at a second position of the plurality of positions. In other or further embodiments, the second part of the optical signal comprises light having a second wavelength different from the first wavelength. In yet further embodiments, the second opto-acoustic conversion material is configured to absorb the light having the second wavelength for generating a second acoustic signal.

The opto-acoustic conversion material may be present locally at the positions where the optical waveguide is arranged to couple out light or as a continuous surrounding, e.g. cladding, of the optical waveguide. Even the solid structure may act as the opto-acoustic conversion material if it has opto-acoustic conversion properties at least adjacent the optical waveguide.

Preferably, the opto-acoustic conversion material has dimensions which maximizes the conversion efficiency at the predefined acoustic wavelength, e.g. the opto-acoustic conversion material has dimensions comparable to half of the acoustic wavelength of the acoustic signal to be generated.

By providing the outcoupling structure with a tilted fiber Bragg grating (FBG), the specific light coupled out by said structure can be easily controlled, e.g., by adapting one or more of the grating distances, slopes and apodizations.

Advantageously, by providing the opto-acoustic coupler with (optical) filtering means, selective outcoupling of respective parts of the optical signal can be achieved at a plurality of positions. Alternatively or in addition, by providing the respective opto-acoustic couplers with opto-acoustic conversion materials having different absorption coefficient for the same wavelength or a subset of wavelengths, selective generation of respective acoustic signals at a plurality of positions can be achieved. Advantageously, by providing the respective opto-acoustic couplers with meta-materials configured to couple out different amount of light of different wavelengths, selective outcoupling of light to the respective opto-acoustic conversion materials can be achieved, as a result of which selective generation of acoustic signals at a plurality of positions can be accomplished. Even more advantageously, by providing the opto-acoustic couplers with multiple layers of different meta-materials, light can be selectively outcoupled and focused into an opto-acoustic conversion material.

Advantageously, by using a set of metal structures embedded in the opto-acoustic conversion material arranged on a surface of an optical waveguide along its longitudinal axes, surface plasmon resonance can be generated along the same axes, thus saving space in a direction perpendicular to the optical waveguide, as a result of which the system remains long and slim.

By providing the opto-acoustic coupler with a focusing lens, more light can be outcoupled to an opto-acoustic conversion material having small dimensions, e.g. half of the acoustic wavelength. Alternatively or in addition, by providing the opto-acoustic coupler with a meta-lens configured to outcouple and focus the light out of the optical waveguide to the opto-acoustic conversion material the system gets simplified, e.g., there is no need for a separate outcoupling structure and/or a focusing lens.

Advantageously, by providing the opto-acoustic coupler with at least one light source coupled to the optical waveguide and configured to generate an optical signal comprising at least two different wavelengths which are selectively outcoupled and/or selectively absorbed in the opto-acoustic conversion material, selective generation of acoustic signals at the plurality of positions can be achieved.

By providing the system with acousto-optic receiver and an optical detector for detecting the acoustic signals, means of monitoring acoustic signal changes indicating integrity of the solid structure can be realized.

Advantageously, the opto-acoustic couplers and/or the acousto-optic receivers are arranged at a plurality of positions forming a two dimensional array, thereby focusing the acoustic signals along a fixed geometrical direction. Even more advantageously, by providing the system with a light source configured to generate a set of adjustable time delays between an optical signal having the first wavelength and an optical signal having the second wavelength, active steering and/or focusing of the acoustic signals to a predefined point, direction and/or acoustic wave-front can be realized. In another aspect of the present disclosure, adaptable directional spatial acoustic emission patterns within a solid structure being interrogated are generated using a selective opto-acoustic emission from an optical waveguide embedded in the solid structure under inspection. The direction of the maximum acoustic emission may be controlled by using selected relative time delays between a set of optical signals transmitted through the optical waveguide to different opto-acoustic outcouplers outcoupling different parts of the optical signal. Different sets of relative time delays are selected so that the times of arrival of the starts of acoustic signals generated by the different parts of the optical signal coincide at points in different directions in the solid structure. As a result, different directional spatial acoustic emission patterns will have a maximum in the direction to those points. The response of the solid structure is measured. By using adaptable directional patterns through the solid structure generated by the selective opto-acoustic emission from an optical waveguide different amounts of inspection resolution and signal to noise ratio can be realized. The required relative time delays may be determined from the acoustic propagation properties along ray paths from the positions where the light from the optical waveguide causes opto-acoustic conversion in the opto-acoustic conversion material. The travel times from the opto-acoustic conversion material where the acoustic signal is generated to the point may be computed e.g. by simulation, and the relative time delays may be selected to compensate for the differences between the respective positions at which the acoustic signals are generated. A directional spatial acoustic emission pattern within a solid structure that peaks in a single three dimensional direction can be realized for example by creating emission from positions distributed over the two dimensional array as seen in projection on the cross-section perpendicular to the array. In an embodiment adaptable directional patterns may be generated by using a plurality of reference directions parallel to a surface of the solid structure nearest the section of the optical waveguide and distributed over a range of angles with respect to a longitudinal direction of the optical waveguide in the section (as used herein, “distributed over a range of angles” means that angles at the bounds of the range and at least one angle between these bounds are included, preferably, but not necessarily at equal angle distances). Thus, measurements according to a discrete angle scan over the surface can be realized using a single optical waveguide. For example, in case of a wing shaped solid structure such as a wind turbine blade, a leading edge surface of the wing may be nearest the section, with the optical waveguide directed along the length of the wing and reference directions in a range that includes the length direction along the wing. As another example, a surface between the edge and the trailing edge of the wing may be nearest the section, with the optical waveguide directed along the length of the wing or transverse to it. The angles fan out in different directions from the section.

In an embodiment directions in said range fan out to points distributed over a full width of the solid structure. In the embodiment of a wing shaped solid object and a section near the leading edge, the angles may fan out so that, beyond some distance from the section, the range of directions reaches the surface around the leading edge up to a full width where opposite surface parts of the wing are perpendicular to the surface part at the leading edge. Similarly, with the section near a surface between the edge and the trailing edge of the wing, the angles may fan out so that, beyond some distance from the section, the range reaches up to a full width between the leading edge and the trailing edge of the wing. Thus the number of positions where opto-acoustic couplers are present may be reduced.

In an embodiment acoustic reflection measurements obtained in response to acoustic signals for the reference directions may be used to determine one or more inspection directions for further inspection. For example an inspection direction may be a direction of largest acoustic reflection, possibly due to a defect.

In another embodiment, reception is performed using an FBG in said section of the optical waveguide or in a second separate optical waveguide. This may be used when the acoustic signal in the inspection direction can propagate along a path that returns to the optical waveguide, or when back reflection or backscattering from defects is measured.

A control circuit may control generation of optical signals with different relative time delays to the optical waveguide. The control circuit may have storage, such as a memory, containing pre-stored data defining sets of relative time delays for the different reference directions, for use to control the relative time delays between generation of the optical signals comprising at least two different wavelengths. The data may define the sets of relative time delays for different reference directions explicitly and/or the data may contain parameters defining positions of where the optical waveguide couples light to the opto-acoustic conversion material and/or speed of sound in different regions to compute relative time delays within the sets of optical pulses for requested directions.

In an embodiment, the coupling of light from the at least part of the optical waveguide and/or the opto-acoustic conversion material to which the light is coupled is optical wavelength selective for different optical selection wavelengths. This makes it possible to cause acoustic emission with different, adaptable time delays from the same optical waveguide by generating optical signals at different optical wavelengths with adaptable delays.

In an embodiment, emission patterns can be created in parallel from separate optical waveguides, to perform inspection at different regions of the solid structure and/or to form advanced patterns of acoustic signals. In another embodiment, different optical wavelengths may be used in different sections. This makes it possible to emit acoustic signals from different sections independently, without requiring additional optical waveguides.

Advantageously, the system and/or the method is/are used for monitoring structural integrity of a solid structure exposed to external conditions affecting its integrity, thereby providing means of damage assessment or predictive maintenance. For example, the system is used to monitor structural integrity of a wind turbine blade.

### BRIEF DESCRIPTION OF DRAWINGS

These and other features, aspects, and advantages of the apparatus, systems and methods of the present disclosure will become better understood from the following description, appended claims, and accompanying drawing wherein:

FIG. 1A illustrates an opto-acoustic interrogator system;

FIGS. 1B-4B illustrate various aspects of opto-acoustic couplers;

FIGS. 5A-5C illustrate various aspects of opto-acoustic interrogator systems comprising a light source and a detector;

FIGS. 6A and 6B illustrate two-dimensional arrays of opto-acoustic couplers;

FIG. 7 illustrates an opto-acoustic interrogator system having phased array functionality;

FIG. 8 illustrates a wind turbine comprising the opto-acoustic interrogator system;

FIGS. 9A, 9B and 9C illustrate wind turbine blades comprising the opto-acoustic interrogator system.

### DESCRIPTION OF EMBODIMENTS

Terminology used for describing particular embodiments is not intended to be limiting of the invention. As used herein, the singular forms “a”, “an” and “the” are intended to include the plural forms as well, unless the context clearly indicates otherwise. The term “and/or” includes any and all combinations of one or more of the associated listed items. It will be understood that the terms “comprises” and/or “comprising” specify the presence of stated features but do not preclude the presence or addition of one or more other features. It will be further understood that when a particular step of a method is referred to as subsequent to another step, it can directly follow said other step or one or more intermediate steps may be carried out before carrying out the particular step, unless specified otherwise. Likewise it will be understood that when a connection between structures or components is described, this connection may be established directly or through intermediate structures or components unless specified otherwise.

Some aspects of the present disclosure can be embodied as an acoustic inspection method for inspecting a structure, preferably a solid structure. In one embodiment, the structure comprises one or more optical fibers or other waveguides, e.g. a bundle comprising a plurality of optical fibers. In another or further embodiment, one or more of the optical fibers have at least a part embedded in the structure. Preferably, a respective optical fiber of the one or more optical fibers (e.g. each fiber) is configured to couple light from the respective optical fiber at a respective position in a section (e.g. axial section) of the embedded part of the optical fiber to opto-acoustic conversion material. This may cause emission of acoustic signals through the structure from the opto-acoustic conversion material. In some embodiments, a respective set of optical pulses is transmitted through the optical fiber. In one embodiment, at least part of the optical fiber is configured to couple light from the optical fiber to opto-acoustic conversion material at respective positions in the section. Preferably, the coupling of light from the at least part of the optical fiber and/or the opto-acoustic conversion material to which the light is coupled are optical wavelength selective for different optical selection wavelengths. Alternatively, or in addition, optical wavelength selectivity can also be provided by filtering and/or reflecting light between the position of the coupling of light from the at least part of the optical fiber and the respective opto-acoustic conversion material at that position. In some embodiments, a respective set of optical pulses of the different optical selection wavelengths is transmitted through the at least part of the optical fiber. In other or further embodiments, relative time delays between transmission of the pulses of the respective set are selected. For example, the relative time delays are selected so that the times of the first arrival of acoustic signals, generated by the optical pulses from the respective set, coincide at a point in the structure, e.g., in the reference direction from said section.

In some embodiments, a plurality of reference directions is selected. In one embodiment, a respective set of optical pulses is transmitted through the respective ones of the plurality of optical fibers for each of the reference directions. In another or further embodiment, for each of the reference directions, a respective response is received from the solid structure to acoustic signals emitted by opto-acoustic emission as a result of the respective set of optical pulse for the reference direction.

The invention is described more fully hereinafter with reference to the accompanying drawings, in which embodiments of the invention are shown. In the drawings, the absolute and relative sizes of systems, components, layers, and regions may be exaggerated for clarity. Embodiments may be described with reference to schematic and/or cross-section illustrations of possibly idealized embodiments and intermediate structures of the invention. In the description and drawings, like numbers refer to like elements throughout. Relative terms as well as derivatives thereof should be construed to refer to the orientation as then described or as shown in the drawing under discussion. These relative terms are for convenience of description and do not require that the system be constructed or operated in a particular orientation unless stated otherwise.

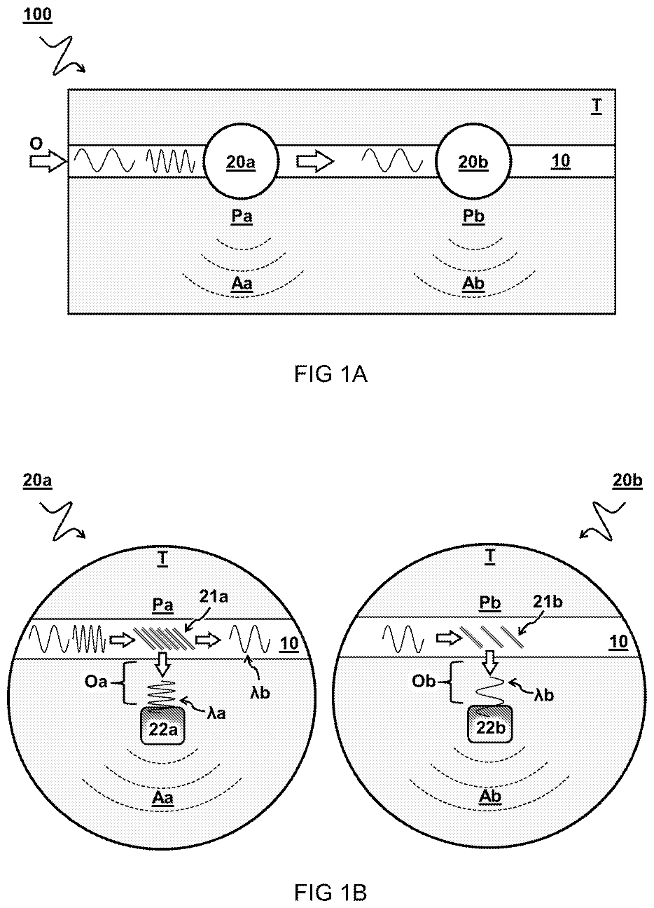

FIG. 1A illustrates an opto-acoustic interrogator system 100 for acoustically interrogating a solid structure T. The system 100 comprises an optical waveguide 10 configured to receive an optical signal O and guide the optical signal O to a plurality of opto-acoustic couplers 20 arranged at a plurality of positions P along the optical waveguide 10.

FIG. 1B illustrates opto-acoustic couplers 20a, 20b comprising outcoupling structures 21a, 21b. In one embodiment, the plurality of opto-acoustic couplers 20 comprises a first opto-acoustic coupler 20a configured to couple a first part Oa of the optical signal O from the optical waveguide 10 into a first opto-acoustic conversion material 22a arranged at a first position Pa of the plurality of positions P, the first part Oa of the optical signal O comprising light having a first wavelength λa, wherein the first opto-acoustic conversion material 22a is configured to absorb the light having the first wavelength λa for generating a first acoustic signal Aa. In another or further embodiment, the plurality of opto-acoustic couplers 20 comprises a second opto-acoustic coupler 20b configured to couple a second part Ob of the optical signal O from the optical waveguide 10 into a second opto-acoustic conversion material 22b arranged at a second position Pb of the plurality of positions P, the second part Ob of the optical signal O comprising light having a second wavelength λb different from the first wavelength λa, wherein the second opto-acoustic conversion material 22b is configured to absorb the light having the second wavelength λb for generating a second acoustic signal Ab.

In one embodiment, the optical waveguide 10 comprises optical fiber. In another or further embodiment, the optical waveguide 10 comprises transparent dielectric waveguide made of plastic and/or glass, liquid light guide, or any other physical solid structure that guides electromagnetic waves in the optical spectrum.

In some embodiments, the opto-acoustic conversion material 22a, 22b is a light receiving material that transiently changes size and/or shape when it receives light. In one embodiment, the opto-acoustic conversion material 22a, 22b is realized by including light absorbing particles (e.g. ink particles or plasmonic materials such as gold or silver) in a transparent material, e.g. Polydimethylsiloxaan (PDMS) or Polyether ether ketone (PEEK). Preferably, the opto-acoustic conversion material 22a, 22b has dimensions that maximizes the opto-acoustic conversion efficiency, e.g. the opto-acoustic conversion material 22a, 22b has dimensions comparable to half of an acoustic wavelength of the generated acoustic signal Aa, Ab.

In one embodiment, the first part Oa of the optical signal O is formed by light having a first wavelength λa, wherein the second part Ob of the optical signal O is formed by light having a second wavelength λb different from the first wavelength λa by at least ten nanometers, preferably by hundred nanometers or more.

In another or further embodiment, the first opto-acoustic coupler 20a comprises a first outcoupling structure 21a configured to couple the first part Oa of the optical signal O from the optical waveguide 10. In another or further embodiment, the second opto-acoustic coupler 20b comprises a second outcoupling structure 21b configured to couple the second part Ob of the optical signal O from the optical waveguide 10. In one embodiment, the first outcoupling structure 21a is configured to couple out more of the light having the first wavelength λa than the light having the second wavelength Ab. In other or further embodiment, the second outcoupling structure 21b is configured to couple out more of the light having the second wavelength λb than the light having first wavelength λa.

Preferably, the outcoupling structure 21a, 21b comprises a tilted FBG, of which the grating distance, slope and apodization define how much light gets coupled out, thus providing means of controlling how much light gets coupled out at the plurality of positions P.

While the present disclosure features the advantageous use of wavelength dependent opto-acoustic couplers for selectively converting respective parts of the optical signal at different positions along the optical waveguide, also other or further optical characteristics or combinations thereof could be used for the selective converting parts of the light at the different couplers. For example, the optical signal may include two or more different polarizations of light. In one embodiment, the first opto-acoustic coupler 20a is configured to convert light having a first polarization into acoustic waves, and the second opto-acoustic coupler 20b is configured to convert light having a second polarization into acoustic waves. For example, the second polarization is transverse or perpendicular with respect to the first polarization. In one embodiment, the first opto-acoustic coupler 20a has a first outcoupling structure 21a such as a first tilted FBG, and the second opto-acoustic coupler 20b has a second outcoupling structure 21b such as a second tilted FBG. In one example, the second tilted FBG has a different spacing of the gratings, e.g. different by a factor of half or one, preferably two or more. In one embodiment, the spacing of the gratings is one and half wavelength of the light to be coupled out, or more. In another example, the second tilted FBG has a different orientation than the first tilted FBG, e.g. rotated by ten, forty five, up to ninety degrees, preferably in a range from twenty up to seventy degrees. In this way the reflectivity for coupling out light with the first polarization can be higher for the first outcoupling structure 21a, e.g. first tilted FBG, than for the second outcoupling structure 21b, e.g. second tilted FBG; and the reflectivity for coupling out light with the second polarization can be higher for the second outcoupling structure 21b, e.g. second tilted FBG, than for the first outcoupling structure 21a, first tilted FBG. Also combinations of different wavelengths and/or polarizations can be used. Also other or further optical characteristics, such as different phases of light, and correspondingly different couplers, could be used.

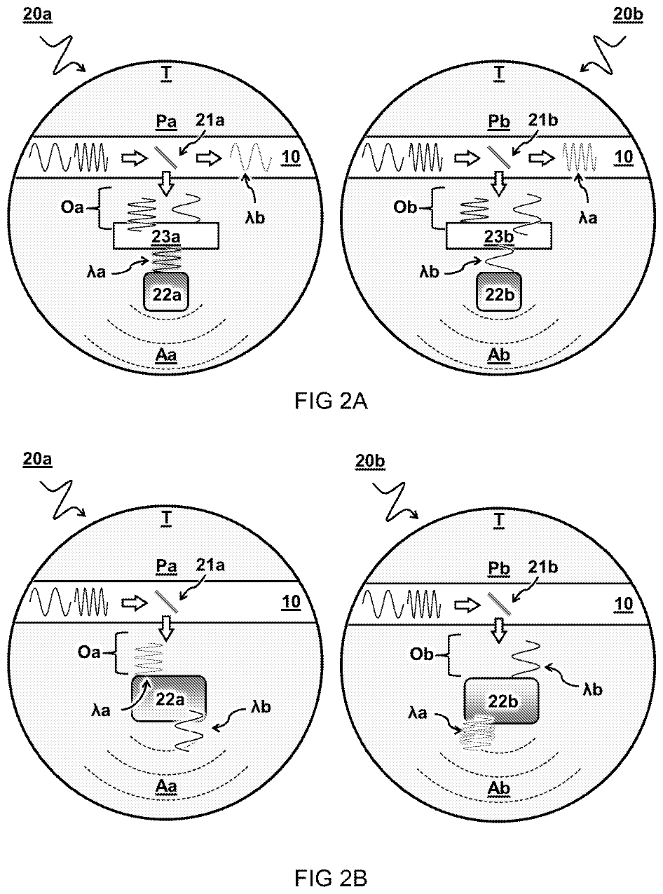

FIG. 2A illustrates opto-acoustic couplers 20a, 20b comprising filtering means 23a, 23b. In one embodiment, the first opto-acoustic coupler 20a comprises a first filtering means 23a arranged between the optical waveguide 10 and the first opto-acoustic conversion material 22a. In another or further embodiment, the second opto-acoustic coupler 20b comprises a second filtering means 23b arranged between the optical waveguide 10 and the second opto-acoustic conversion material 22b. In one embodiment, the first filtering means 23a is configured to receive the first part Oa of the optical signal O and pass more of the light having the first wavelength λa to the first opto-acoustic conversion material 22a than the light having the second wavelength λb. In another or further embodiment, the second filtering means 23b is configured to receive the second part Ob of the optical signal O and pass more of the light having the second wavelength λb to the second opto-acoustic conversion material 22b than the light having the first wavelength λa. Preferably, the filtering means 23a, 23b comprises respective dichroic filters configured to exclusively pass one of the wavelengths of light intended for the respective opto-acoustic coupler while blocking all other wavelength(s) intended for other opto-acoustic coupler(s). In some embodiments, the filtering means 23a, 23b comprises wavelength-dependent tilted FBG. In another or further embodiment, the filtering means 23a, 23b comprises meta-material cladding. In yet further embodiments, the filtering means 23a, 23b comprises wavelength-, polarization-, or phase-dependent filters.

FIG. 2B illustrates opto-acoustic couplers 20a, 20b comprising opto-acoustic conversion materials 22a, 22b. In one embodiment, the first opto-acoustic conversion material 22a has an absorption coefficient that is higher for the light having the first wavelength λa than for the light having the second wavelength λb. In another or further embodiment, the second opto-acoustic conversion material 22b has an absorption coefficient that is higher for the light having the second wavelength λb than for the light having the first wavelength λa.

In some embodiments, the plurality of opto-acoustic couplers 20 is configured to generate acoustic signals Aa, Ab at the plurality of positions P, wherein at least two of the acoustic signals Aa, Ab have the same or similar amount of acoustic energy, e.g. within ten percent, preferably within five percent, more preferably within one percent or less. In one embodiment, the plurality of opto-acoustic couplers 20 comprises subsequent tilted FBG's or cladding materials that reflect ever more light along the optical waveguide 10. In another or further embodiment, each tilted FBG and/or cladding material couples out different wavelength of light. In yet further embodiments, the amount of outcoupled light is matched with efficiency of a respective opto-acoustic conversion materials 22a, 22b to outcouple the same or similar amount of acoustic energy.

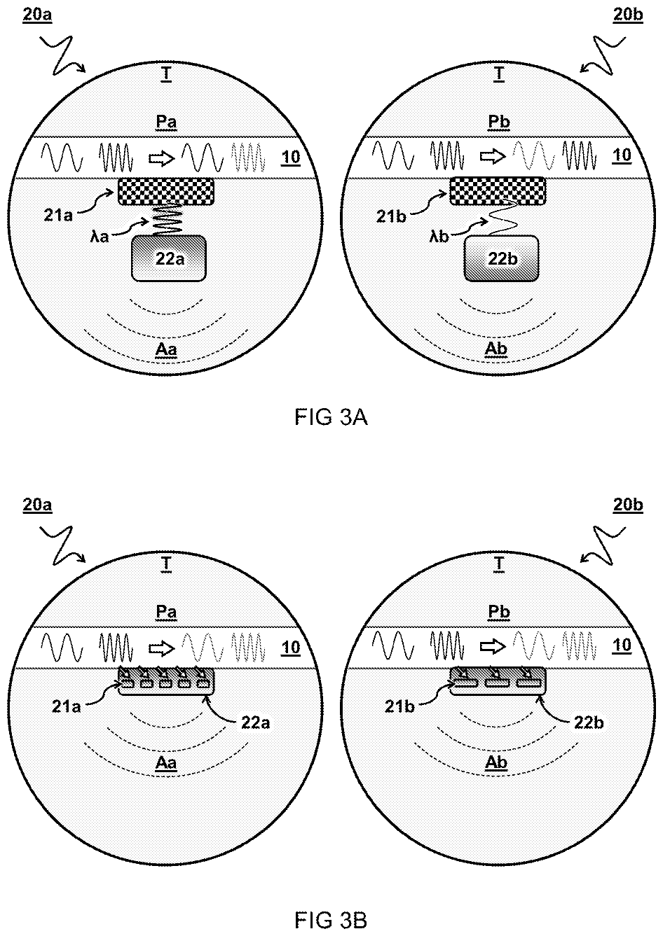

FIG. 3A illustrates outcoupling structures 21a, 21b comprising a meta-material. In one embodiment, the first outcoupling structure 21a comprises a first meta-material arranged on a surface of the optical waveguide 10 and configured, e.g. by comprising meta-material sub-structures of different periodicity and/or size and/or (relative) refraction index, to couple out, from the optical waveguide 10, more of the light having the first wavelength λa than the light having the second wavelength λb. In another or further embodiment, the second outcoupling structure 21b comprises a second meta-material arranged on a surface of the optical waveguide 10 and configured, e.g. by comprising meta-material sub-structures of different periodicity and/or size and/or (relative) refraction index, to couple out, from the optical waveguide 10, more of the light having the second wavelength λb than the light having the first wavelength λa. In yet further embodiments, the meta-material comprises a pattern of at least two refractive indexes and/or at least two different materials. In one embodiment, multiple layers of meta-materials comprising sub-structures of different periodicity and/or size and/or (relative) refraction index are provided on the optical waveguide 10. In another or further embodiment, the meta-material comprises an opto-acoustic absorbing material. Alternatively, or in addition to the meta-material being used for coupling out light having a respective wavelength, also other outcoupling structures can be used. For example, a tilted FBG (not shown here) can be used to couple out the light and the meta-material can be used additionally or alternatively for other functions, e.g. one or more of filtering, focusing, and/or absorbing of the light.

As background, Yu Lei et al. (Vol. 30, No. 22/24 Oct. 2022 /Optics Express 40916) describes meta-surface around the side surface of an optical fiber for light focusing. The contents of this article, and in particular the way in which meta-surfaces can be formed around optical fibers to couple out (focused) light, are incorporated herein in their entirety. As described in this article a series of identical dielectric rings can be dressed around the side surface of a microfiber and their positions can be adjusted along the microfiber axis. In this way guided waves can be extracted into free-space radiation with continuously controllable phase shift and circular-arc-shaped line focusing can be achieved. The article further demonstrates that the off-fiber foci could be rotated around the fiber axis by tuning the polarization of the guided waves. In addition, the article demonstrates that the shape of the focus could be further tuned by introducing symmetry breaking into the dielectric rings.

FIG. 3B illustrates outcoupling structures 21a, 21b comprising metal structures. In one embodiment, the first outcoupling structure 21a comprises a first set of metal structures embedded in the first opto-acoustic conversion material 22a arranged on a surface of the optical waveguide 10 and configured, e.g. by tuning a periodicity and/or size of the metal structures, to couple out, from the optical waveguide 10 to the first opto-acoustic conversion material 22a, more of the light having the first wavelength λa than the light having the second wavelength λb, e.g. using a plasmon resonance interaction with the first part Oa of the optical signal O. In another or further embodiment, the second outcoupling structure 21b comprises a second set of metal structures embedded in the second opto-acoustic conversion material 22b arranged on a surface of the optical waveguide 10 and configured, e.g. by tuning a periodicity and/or size of the metal structures, to couple out, from the optical waveguide 10 to the second opto-acoustic conversion material 22b, more of the light having the second wavelength λb than the light having the first wavelength λa, e.g. using a plasmon resonance interaction with the second part Ob of the optical signal O. In yet further embodiments, the metal structures are embedded in a meta-material.

Alternatively, or in addition to the metal structures being used for coupling out light having a respective wavelength, also other outcoupling structures can be used. For example, a tilted FBG (not shown here) can be used to couple out the light and the metal structures can be used additionally or alternatively for other functions, e.g. one or more of filtering and/or absorbing of the light.

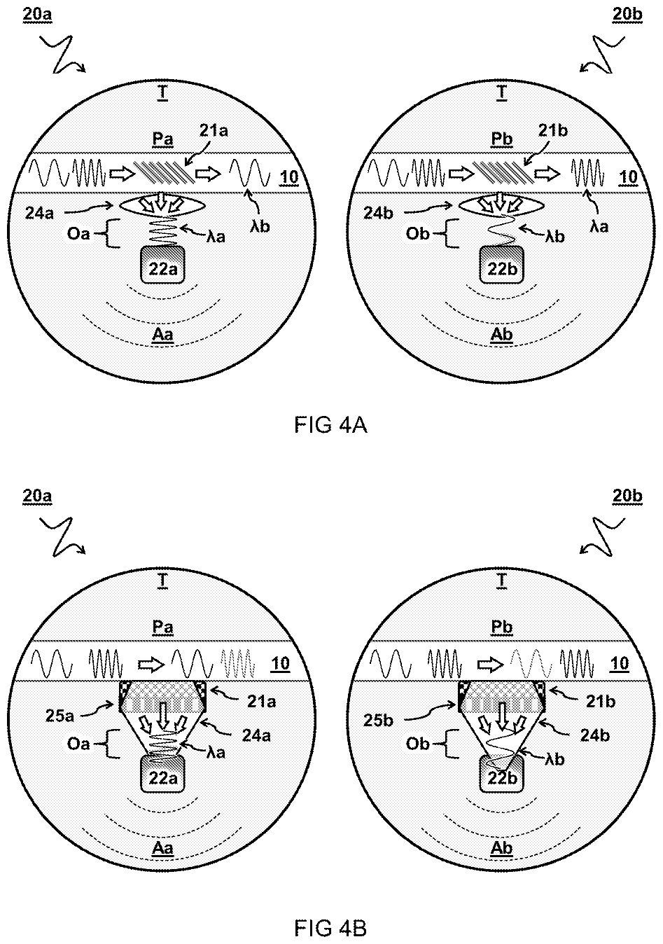

FIG. 4A illustrates opto-acoustic couplers 20a, 20b comprising focusing lenses 24a, 24b. In one embodiment, the first opto-acoustic coupler 20a comprises a first focusing lens 24a arranged between the first outcoupling structure 21a and the first opto-acoustic conversion material 22a, wherein the first focusing lens 24a is configured to focus the first part Oa of optical signal O from the optical waveguide 10 to the first opto-acoustic conversion material 22a. In another or further embodiment, the second opto-acoustic coupler 20b comprises a second focusing lens 24b arranged between the second outcoupling structure 21b and the second opto-acoustic conversion material 22b, wherein the second focusing lens 24b is configured to focus the second part Ob of optical signal O from the optical waveguide 10 to the second opto-acoustic conversion material 22b.

FIG. 4B illustrates opto-acoustic couplers 20a, 20b comprising meta-lenses 24a, 24b. In one embodiment, the first opto-acoustic coupler 20a comprises a first meta-lens 25a arranged between the first outcoupling structure 21a and the first opto-acoustic conversion material 22a; the first meta-lens 25a having a structure, e.g. an aperiodic structure, configured to collimate or focus the first part Oa of optical signal O from the optical waveguide 10 to the first opto-acoustic conversion material 22a. In another or further embodiment, the second opto-acoustic coupler 20b comprises a second meta-lens 25b arranged between the second outcoupling structure 21b and the second opto-acoustic conversion material 22b; the second meta-lens 25b having a structure, e.g. an aperiodic structure, configured to collimate or focus the second part Ob of optical signal O from the optical waveguide 10 to the second opto-acoustic conversion material 22b. In yet further embodiments, at least part of the first and/or second meta-material arranged on the surface of the optical waveguide 10 forms a respective meta-lens 25a, 25b having a structure, e.g. an aperiodic structure, configured to focus the respective outcoupled part Oa, Ob of the optical signal O from the optical waveguide 10 into the respective opto-acoustic conversion material 22a, 22b. In one embodiment, a focal point is formed in the respective opto-acoustic conversion material 22a, 22b. Alternatively, or in addition to the meta-material 21a, 21b being used for coupling out light having a respective wavelength, also other outcoupling structures can be used. For example, a tilted FBG (not shown here) can be used to couple out the light and a meta-material (e.g. 25a, 25b) can be used additionally or exclusively for other functions, e.g. as a meta-lens.

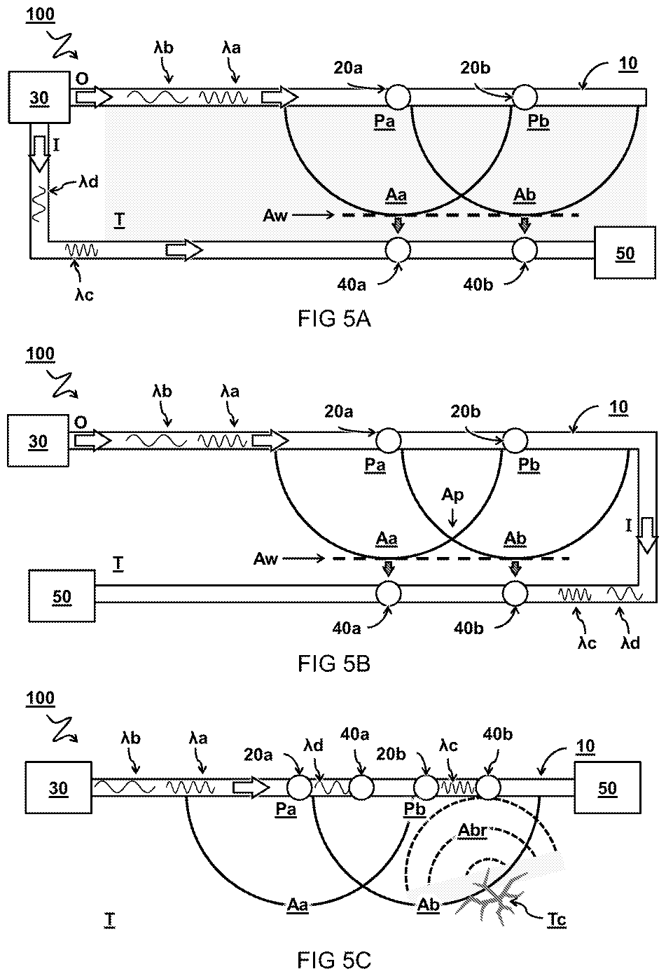

FIG. 5A illustrates the system 100 comprising at least one light source 30 configured to generate an optical signal O comprising light having the first wavelength λa and/or the second wavelength λb, and couple the optical signal O into the optical waveguide 10. In one embodiment, the optical signal O is coupled into optical waveguide 10 using a two-dimensional grating coupler. In another or further embodiment, the optical signal O is coupled into optical waveguide 10 using GRIN lens.

In some embodiments, the system 100 comprises an acousto-optic receiver 40a and an optical detector 50. In one embodiment, the acousto-optic receiver 40a is configured to change its optical characteristic depending on reception of the first acoustic signal Aa and/or the second acoustic signal Ab. In another or further embodiment, the change of the optical characteristic is configured to cause a change of an optical interrogation signal I provided to the acousto-optic receiver 40a.

In some embodiments, the optical interrogation signal I comprises light having a third wavelength λc and/or fourth wavelength λd. In one embodiment, the optical detector 50 is configured to detect said change of the optical interrogation signal I.

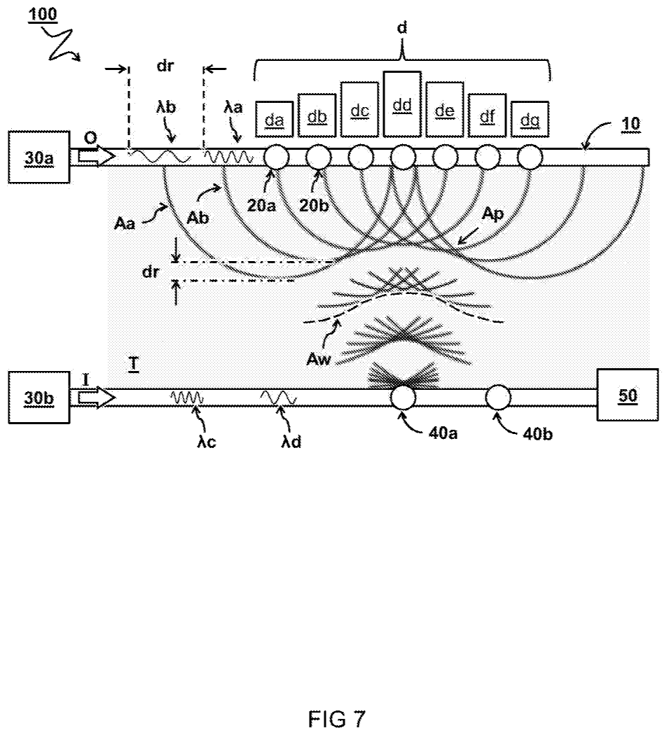

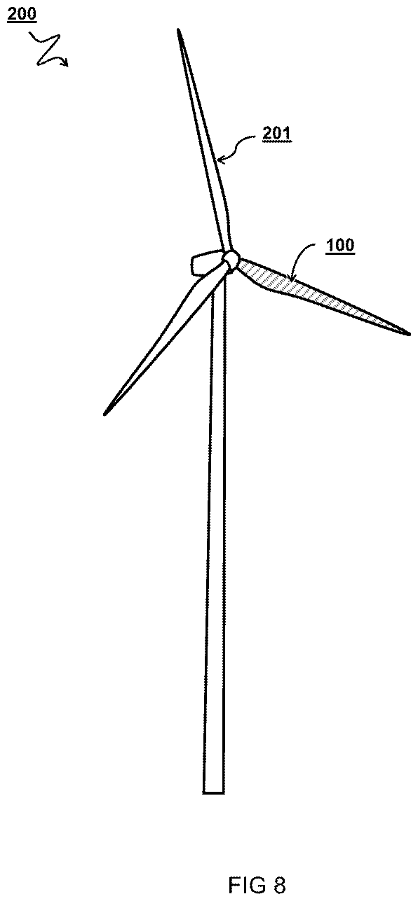

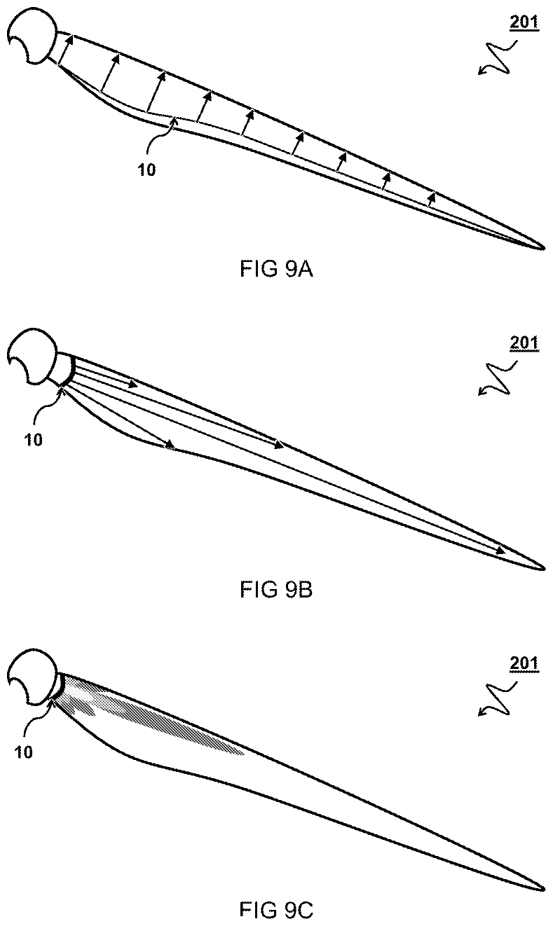

In some embodiments, the optical interrogation signal I is generated by the same light source 30 as the optical signal O. In other or further embodiments, (e.g. as shown in FIG. 7), the optical interrogation signal I is generated by a separate light source 30b. In one embodiment, e.g. as shown in FIG. 5B or 5C, the optical interrogation signal I is coupled into the same optical waveguide 10 as the optical signal O. For example, the same light source 30 is used to generate the optical signal O and/or optical interrogation signal I. In another or further embodiment, e.g. as shown in FIG. 5A, the optical signal O is coupled into a first optical waveguide, while the optical interrogation signal I is coupled into a second optical waveguide 10b.

In some embodiments, e.g. as shown in FIGS. 5B and 5C, the acousto-optic receiver 40a is arranged in the same optical waveguide 10 as the plurality of opto-acoustic couplers 20. In one embodiment, as shown in FIG. 5C, the acousto-optic receiver 40a is arranged along the same optical waveguide 10 between the first opto-acoustic coupler 20a and second opto-acoustic coupler 20b. In another or further embodiment, one or more acousto-optic receivers 40a, 40b are arranged in another part of the same optical waveguide 10. In another or further embodiment, e.g. as shown in FIG. 5A, one or more acousto-optic receivers 40a, 40b are arranged in a second optical waveguide 10b. In yet further embodiment, the optical detector 50 and the light source 30 form an optical interrogator component.

In some embodiments, a change of a respective optical characteristic of the acousto-optic receiver 40a, 40b is measured as a function of time, wherein time at which the optical characteristic changes indicates an arrival time of the respective acoustic signal Aa, Ab at the respective acousto-optic receiver 40a, 40b. In another or further embodiment, the changes in optical characteristics of the acousto-optic receivers 40a, 40b are recorded as time-dependent signals. In other or further embodiments, the time-dependent signals are individually delayed with respect to each other and summed together to obtain a coherently amplified signal for a given target point Ap within the solid structure T. In yet further embodiments, the individual delays of the time-dependent signals equal to the shortest time needed for the respective acoustic signal Aa, Ab to travel from the target point Ap to the respective acousto-optic receiver 40a, 40b. In yet further embodiments, the acousto-optic receiver 40a is arranged along the length of the optical waveguide 10, in-between or adjacent to the plurality of opto-acoustic couplers 20, wherein the acousto-optic receiver 40a is configured to measure acoustic signals Aa, Ab generated by the opto-acoustic conversion material 22a, 22b and/or reflected from a portion Tc of the solid structure T as illustrated in FIG. 5C. In one embodiment, the plurality of opto-acoustic couplers 20 comprises at least three opto-acoustic couplers 20a, 20b, 20c arranged non-collinearly on a single optical waveguide 10 at a plurality of positions P.

In some embodiments, the acousto-optic receiver 40a comprises (another) FBG, which may be a regular (non-tilted) FBG, pi-shifted FBG, et cetera. In principle, also a tilted FBG could the used for sensing acoustic waves. For example, the same or other tilted FBG could be used for coupling out light from the optical waveguide 10 and/or used for measuring the effect of acoustic waves Aa, Ab on the FBG by measuring which (variable) wavelengths (λc, λd) of light are transmitted, i.e. wavelengths which are not coupled out by the tilted FBG as illustrated in FIG. 5C. In another or further embodiment, the acousto-optic receiver 40a comprises other type of acousto-optic receiver 40a based on e.g. optical interferometry.

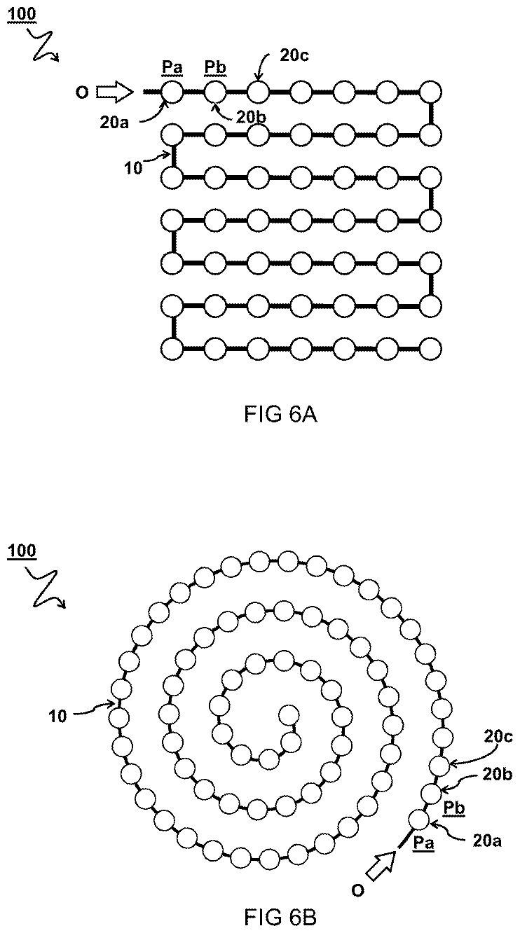

FIG. 6 illustrates an array of opto-acoustic couplers 20 and/or acousto-optic receivers 40a, 40b arranged at a plurality of positions P forming a two dimensional array for three dimensional steering and/or focusing of the plurality of acoustic signals A through the solid structure T to the respective acousto-optic receiver 40a, 40b.

In one embodiment, the plurality of opto-acoustic couplers 20 and/or the acousto-optic receivers 40a, 40b is/are arranged at a plurality of positions P forming a rectangular grid, e.g. as shown in FIG. 6A, for phased-array based steering/focusing of the plurality of acoustic signals A. In another embodiment, the plurality of opto-acoustic couplers 20 and/or the acousto-optic receivers 40a, 40b is/are arranged at a plurality of positions P forming a spiral, e.g. as shown in FIG. 6B, for generating a donut- or gaussian-shaped acoustic pattern of the plurality of acoustic signals A.

FIG. 7 illustrates the system 100 comprising light source 30 configured to provide a set of adjustable time delays d between an optical signal O having the first wavelength λa and an optical signal O having the second wavelength λb. In some embodiments, the set of adjustable time delays d is configured to cause a steered and/or focused emission of the plurality of acoustic signals (Aa, Ab) through the solid structure T to the acousto-optic receivers 40a, 40b. In one embodiment, at least one of the set of adjustable time delays d corresponds to a relative time delay dr between at least two of the plurality of acoustic signals Aa, Ab. In another or further embodiment, the set of adjustable time delays d is configured to cause at least partial interference of the plurality of acoustic signals Aa, Ab at a target point Ap or form an acoustic wave-front Aw.

One embodiment comprises a solid structure T comprising the opto-acoustic interrogator system 100, wherein the optical waveguide 10 is at least partially embedded in the solid structure T for acoustically interrogating the solid structure T.

Some embodiments comprise guiding, by an optical waveguide 10, an optical signal O to a plurality of opto-acoustic couplers 20 arranged at a plurality of positions P along the optical waveguide 10. In one embodiment, the plurality of opto-acoustic couplers 20 comprises a first opto-acoustic coupler 20a and a second opto-acoustic coupler 20b.

Another or further embodiments comprise coupling, by the first opto-acoustic coupler 20a, a first part Oa of the optical signal O from the optical waveguide 10 into a first opto-acoustic conversion material 22a arranged at a first position Pa of the plurality of positions P, the first part Oa of the optical signal O comprising light having a first wavelength λa, wherein the first opto-acoustic conversion material 22a absorbs the light having the first wavelength λa for generating a first acoustic signal Aa.

Other or further embodiments comprise coupling, by a second opto-acoustic coupler 20b, a second part Ob of the optical signal O from the optical waveguide 10 into a second opto-acoustic conversion material 22b arranged at a second position Pb of the plurality of positions P, the second part Ob of the optical signal O comprising light having a second wavelength Ab different from the first wavelength λa, wherein the second opto-acoustic conversion material 22b absorbs the light having the second wavelength λb for generating a second acoustic signal Ab.

Some embodiments comprise acoustically interrogating solid structure T using the first acoustic signal Aa and/or the second acoustic signal Ab. One embodiment comprises receiving the first acoustic signal Aa and/or the second acoustic signal Ab using an acousto-optic receiver 40a. Another or further embodiment comprises measuring a change of an optical interrogation signal I caused by a change of an optical characteristic of an acousto-optic receiver 40a, wherein the change of the optical characteristic depends on reception of the first acoustic signal Aa and/or the second acoustic signal Ab.

Yet further embodiments comprise repeating the guiding, the coupling by the respective opto-acoustic coupler and the interrogating during a prolonged period of time while the solid structure T is exposed to external conditions deteriorating integrity of the solid structure T and comparing said repeated measurements with previous measurements. One embodiment comprises monitoring a progressive amount of integrity deterioration of a solid structure T at different instances of time during the prolonged period of time.

For the purpose of clarity and a concise description, features are described herein as part of the same or separate embodiments, however, it will be appreciated that the scope of the invention may include embodiments having combinations of all or some of the features described. For example, while embodiments were shown for outcoupling light by means of a tilted FBG, meta-materials, and metal structures also alternative ways or combinations may be envisaged by those skilled in the art having the benefit of the present disclosure for achieving a similar function and result. E.g. tilted FBG's may be used in combination with the meta-materials and/or the metal structures. Of course, it is to be appreciated that any of the other above embodiments or methods may be combined with one or more other embodiments or methods to provide even further improvements in finding and matching designs and advantages, e.g., tilted FBG's may be used in combination with meta-materials fulfilling, metal structures and/or meta-lenses for other functions, e.g., one or more filtering, focusing or absorbing of light. It is appreciated that this disclosure offers particular advantages to monitoring structural integrity of a wind turbine blade, and in general can be applied for any application wherein monitoring of health of a solid structure is required.

In interpreting the appended claims, it should be understood that the word “comprising” does not exclude the presence of other elements or acts than those listed in a given claim; the word “a” or “an” preceding an element does not exclude the presence of a plurality of such elements; any reference signs in the claims do not limit their scope; several “means” may be represented by the same or different item(s) or implemented structure or function; any of the disclosed devices or portions thereof may be combined together or separated into further portions unless specifically stated otherwise. Where one claim refers to another claim, this may indicate synergetic advantage achieved by the combination of their respective features. But the mere fact that certain measures are recited in mutually different claims does not indicate that a combination of these measures cannot also be used to advantage. The present embodiments may thus include all working combinations of the claims wherein each claim can in principle refer to any preceding claim unless clearly excluded by context.

1. An opto-acoustic interrogator system at least partially embedded in a solid structure for acoustically interrogating the solid structure, the system-comprising an optical waveguide configured to receive an optical signal and guide the optical signal to a plurality of opto-acoustic couplers arranged at a plurality of positions along the optical waveguide, wherein the plurality of opto-acoustic couplers-comprises:
a first opto-acoustic coupler configured to couple a first part of the optical signal from the optical waveguide into a first opto-acoustic conversion material arranged at a first position of the plurality of position, wherein the first part of the optical signal comprises light having a first wavelength, and wherein the first opto-acoustic conversion material is configured to absorb the light having the first wavelength for generating a first acoustic signal, and
a second opto-acoustic coupler configured to couple a second part of the optical signal from the optical waveguide into a second opto-acoustic conversion material arranged at a second position of the plurality of positions, wherein the second part of the optical signal comprises light having a second wavelength different from the first wavelength, and wherein the second opto-acoustic conversion material is configured to absorb the light having the second wavelength for generating a second acoustic signal.

2. The system according to claim 1,
wherein the first opto-acoustic coupler comprises a first meta-material arranged on a surface of the optical waveguide and configured to couple out, from the optical waveguide-into the first opto-acoustic conversion material more of the light having the first wavelength than the light having the second wavelength;
wherein the second opto-acoustic coupler comprises a second meta-material arranged on a surface of the optical waveguide and configured to couple out, from the optical waveguide into the second opto-acoustic conversion material, more of the light having the second wavelength than the light having the first wavelength; and
wherein the meta-material comprises a pattern of at least two refractive indexes and/or at least two different materials.

3. The system according to claim 2,
wherein the first meta-material comprises a first set of metal structures having a first periodicity configured to couple out the light having the first wavelength using a plasmon resonance interaction determined by the first periodicity; and
wherein the second meta-material comprises a second set of metal structures having a second periodicity, different from the first periodic structure, configured to couple out the light having the second wavelength using a plasmon resonance interaction determined by the second periodicity.

4. The system according to claim 2, wherein at least part of the first and/or the second meta-material arranged on the surface of the optical waveguide forms a respective meta-lens having a structure configured to focus the respective outcoupled part of the optical signal from the optical waveguide into the respective opto-acoustic conversion material.

5. The system according to claim 1,
wherein the first opto-acoustic coupler comprises a first filter arranged between the optical waveguide and the first opto-acoustic conversion material for receiving the first part of the optical signal, wherein the first filter is configured to pass the light having the first wavelength to the first opto-acoustic conversion material while blocking any light having the second wavelength from reaching the first opto-acoustic conversion material; and
wherein the second opto-acoustic coupler comprises a second filter arranged between the optical waveguide and the second opto-acoustic conversion material for receiving the second part of the optical signal, wherein the second filter is configured to pass the light having the second wavelength to the second opto-acoustic conversion material while blocking any light having the first wavelength from reaching the second opto-acoustic conversion material.

6. The system according to claim 1, comprising an acousto-optic receiver and an optical detector,
wherein the acousto-optic receiver is configured to change an optical characteristic of the acousto-optic receiver depending on reception of the first acoustic signal- and/or the second acoustic signal,
wherein the change to the optical characteristic is configured to cause a change of an optical interrogation signal provided to the acousto-optic receiver; and
wherein the optical detector is configured to receive the optical interrogation signal and detect the change.

7. The system according to claim 1, wherein the acousto-optic receiver is arranged along a length of the optical waveguide-between the first opto-acoustic coupler and the second opto-acoustic coupler, and wherein the acousto-optic receiver is configured to measure acoustic signals generated by the first and/or second opto-acoustic conversion material.

8. The system according to claim 1, comprising at least one light source configured to:
generate the optical signal comprising the light having the first wavelength and the light having the second wavelength; and
couple the optical signal into the optical waveguide.

9. The system according to claim 8,
wherein the light source is configured to provide a set of adjustable time delays between an the optical signal having the first wavelength and an the optical signal having the second wavelength;
wherein the set of adjustable time delays is configured to cause a steered and/or focused emission of the plurality of acoustic signals through the solid structure to the acousto-optic receivers,
wherein at least one of the set of adjustable time delays corresponds to a relative time delay between at least two of the plurality of acoustic signals, and
wherein the set of adjustable time delays is configured to cause at least partial interference of the plurality of acoustic signals at a target point or form an acoustic wave-front.

10. The system according to claim 1, wherein the plurality of opto-acoustic couplers comprises at least three opto-acoustic couplers arranged along the same optical waveguide at non-collinear positions.

11. The system according to claim 9, wherein the plurality of opto-acoustic couplers, are arranged at non-collinear positions-forming a two dimensional array of couplers,
wherein the light source is configured to generate the optical signal comprising light having a set of different wavelengths corresponding to different couplers of the two dimensional array of couplers, and
wherein the different wavelengths are generated with respective time delays configured to generate a combined acoustic signal constructively interfering at a point in the solid structure.

12. (canceled)

13. A method for acoustically interrogating a solid structure (T), the method comprising:
guiding, by an optical waveguide that is at least partially embedded in the solid structure, an optical signal to a plurality of opto-acoustic couplers arranged at a plurality of positions along the optical waveguide, wherein the plurality of opto-acoustic couplers comprises a first opto-acoustic coupler and a second opto-acoustic coupler;
coupling, by the first opto-acoustic coupler, a first part of the optical signal from the optical waveguide into a first opto-acoustic conversion material arranged at a first position of the plurality of positions, wherein the first part of the optical signal comprises light having a first wavelength, and wherein the first opto-acoustic conversion material absorbs the light having the first wavelength for generating a first acoustic signal, and
coupling, by the second opto-acoustic coupler, a second part of the optical signal from the optical waveguide into the a second opto-acoustic conversion material-arranged at a second position of the plurality of positions, wherein the second part of the optical signal comprises light having a second wavelength-different from the first wavelength, and wherein the second opto-acoustic conversion material absorbs the light having the second wavelength for generating a second acoustic signal.

14. The method according to claim 13, the method comprising:
generating a respective acoustic signal using the first opto-acoustic coupler and/or the second opto-acoustic coupler embedded with the optical waveguide in the solid structure;
measuring the respective acoustic signal using an acousto-optic receiver-embedded in the solid structure, wherein the respective acoustic signal has passed through at least a part of the solid structure; and
determining a structural integrity of the part of the solid structure based on the measuring the respective acoustic signal.

15. The method according to claim 13, the method comprising repeatedly performing:
generating a respective acoustic signal using the first opto-acoustic coupler and/or the second opto-acoustic coupler embedded with the optical waveguide in the solid structure;
measuring the respective acoustic signal using an acousto-optic receiver embedded in the solid structure, wherein the respective acoustic signal has passed through at least a part of the solid structure;
determining a structural integrity of the part of the solid structure based on the measuring of the respective acoustic signal; and
wherein the generating, the measuring, and the determining are repeatedly performed repeatedly different instances of time while the solid structure is exposed to external conditions for monitoring the structural integrity of the solid structure.

16. The system according to claim 8, wherein the light source is configured to control relative time delays between a set of optical signals transmitted by the light source through an optical waveguide to different opto-acoustic couplers, and wherein the relative time delays are selected so that times of arrival of starts of acoustic signals generated by the set of optical signals coincide at points in different directions in the solid structure.

17. The system according to claim 16, wherein the relative time delays are determined from acoustic propagation properties along ray paths between positions where the light from the optical waveguide causes opto-acoustic conversion in the opto-acoustic conversion material to the point at which the starts of acoustic signals generated by the set of optical signals coincide in the solid structure.

18. The system according to claim 16, wherein the relative time delays are configured to generate an adaptable directional spatial acoustic emission pattern for providing different amounts of inspection resolution and signal to noise ratio within the solid structure.

19. The system according to claim 18, wherein multiple adaptable directional spatial acoustic emission patterns are generated in parallel from separate optical waveguides to perform inspection at different regions of the solid structure and/or to form advanced patterns of acoustic signals within the solid structure.

20. The system according to claim 1, wherein the solid structure comprises a wing shape.

21. The system according to claim 20, wherein the optical waveguide is embedded along a longitudinal direction of the wing shape.
